(19) United States
(12) Patent Application Publication
(10) Pub. No.: US 2013/0235372 A1
(43) Pub. Date: Sep. 12, 2013

(54) MEASURING DEVICE AND METHOD FOR DETERMINING A MEASURED VARIABLE AT ONE END OF A ROD-SHAPED PRODUCT

(71) Applicant: HAUNI MASCHINENBAU AG, Hamburg (DE)

(72) Inventor: Helmut VOSS, Neumuenster (DE)

(73) Assignee: Hauni Maschinenbau Ag, Hamburg (DE)

(21) Appl. No.: 13/788,826

(22) Filed: Mar. 7, 2013

(30) Foreign Application Priority Data
Mar. 7, 2012 (DE) 102012203579.6

(51) Int. Cl. G01N 21/95

(52) U.S. Cl. CPC G01N 21/95
USPC 356/237.2

(57) ABSTRACT

A measuring device for determining a measured variable at one end of a rod-shaped product includes an optical displacement sensor which includes a light source producing light that is scanned across an entire end face of the rod-shaped product to be examined and a light detector for detecting light that is reflected at the end face of the rod-shaped product to generate a measuring signal. A processing device is coupled to receive the measuring signal to determine a quantitative profile of the entire end face of the rod-shaped product.

### CROSS-REFERENCE TO RELATED APPLICATION

This application claims the priority of German Patent Application No. DE 10 2012 203 579.6, filed on Mar. 7, 2012, the subject matter of which is incorporated herein by reference.

### BACKGROUND OF THE INVENTION

The present invention relates to a measuring device for determining a measured variable at one end of a rod-shaped product, for example, of the tobacco processing industry with the aid of an optical sensor which comprises a light source for illuminating the end face of the rod-shaped product and a light detector for detecting the light reflected by the end face of the rod-shaped product, and for generating a measuring signal and transmitting of this signal to a signal processing device. The invention furthermore relates to a corresponding measuring method.

German patent document DE 36 18 190 A1 discloses a device for optically testing the ends of rod-shaped tobacco articles with the aid of a light fiber bundle focused onto the end face of the rod-shaped tobacco article, for which the ends facing away are assigned to a light transmitter and a light receiver. The light receiver is linked to an evaluation circuit which up-integrates the intensity of the light reflected by the end face of the tobacco article for each individual cigarette. The integrated intensity of the reflected light represents a measure of the condition and/or the density of the cigarette end and can be used as criteria for ejecting cigarettes recognized as being defective. A similar testing device is also known from the European patent document EP 0 843 974 B1.

German patent document DE 38 22 520 C2 discloses a device for testing the ends of cigarettes, wherein a transmitter directs a beam of light under an acute angle onto the end face of the cigarette to be examined, so that if tobacco is missing at the cigarette end the light beam reflected on the inside of the cigarette paper can be recorded by a receiver. The sensor then generates a corresponding error signal which results in the ejection of the defective cigarettes.

European patent document EP 0 585 686 B1 discloses an optical device for testing the filling level of cigarettes and is provided with a light source for illuminating the end face of a cigarette, a focusing lens with fixed focus and a detector. The focal plane for the lens is directed toward an edge at the end of the cigarette. The sensor is designed to detect the contrast of the image of the cigarette end face, focused by the lens onto the sensor. With an optimally filled cigarette, the detected contrast is at a maximum. However if the contrast signal falls below a predetermined threshold value, an ejection signal is issued. A similar testing device of this type is also known from the European patent document EP 0 630 586 B2.

European patent document EP 1 099 388 A2 discloses an off-line testing apparatus for detecting the presence of tobacco at the burn end of a cigarette, based on an infrared transmission measurement. For this, cigarettes are transported with the aid of a drum past a tobacco detection device with an infrared light source which emits an infrared beam directed in axial direction onto the burn end of the cigarette. The infrared light that exits radially from the cigarette is then recorded by four infrared detectors, arranged along the circumference of the cigarette. Provided the intensity of the infrared light which is transmitted through the burn end of the cigarette does not exceed specified threshold value, the cigarette is categorized as acceptable.

All of the above-described measuring and testing devices are based on measuring the intensity of the light, reflected by the end face of the rod-shaped product or penetrating the end face of the rod-shaped product. These methods are imprecise and do not provide differentiated, quantitative values, but only provide a binary statement to the effect that the examined or tested product either meets or does not meet the quality requirements.

According to the European patent document EP 1 053 942 B1, the light beam from a laser is expanded with the aid of a lens and a structured, planar light pattern is generated with the aid of an aperture and is then focused onto a cigarette head. A lens focuses the reflected light onto a position-sensitive detector. Reflected light that is received by the detector arrives an angle which deviates from zero, relative to the radiating light. The aperture comprises a larger opening for illuminating a central region of an end face of a cigarette head and a circle of smaller openings, arranged concentrically around the larger opening, for illuminating the end of the cigarette paper. Based on a displacement of the light spot generated on the detector with the larger aperture, relative to the circle of light spots generated with the smaller openings, it is possible to conclude, for example, that tobacco filling material is missing at the cigarette head which then results in the ejection of the cigarette. In case of a format change, however, the aperture must be replaced depending on the cigarette diameter, wherein this is involved and subject to errors. In addition, even a small error in the positioning of the radiated-in light pattern, relative to the cigarette head, can lead to an incorrect measuring result which means either the ejection of defective cigarettes or the acceptance of defective cigarettes.

A similar testing device is known from the European patent document EP 1 176 092 B1. In that case, each cigarette head is irradiated with a light pattern formed with three superimposed circles which partially illuminate the end face to be examined. In addition to the required precise positioning of the also provided aperture, relative to the cigarette heads, a plurality of individual light sources for generating the light pattern is also provided. These light sources must be positioned precisely, relative to each other as well as relative to the aperture, so as to obtain an error-free measuring result. Generating the light pattern in each aperture opening that corresponds to a cigarette is furthermore extremely involved.

### SUMMARY

It is therefore an object of the present invention to provide a measuring device and a measuring method which can provide precise, quantitative values with little expenditure, thereby making it possible to provide detailed statements on the product quality.

The above and other objects are solved according to the invention by provision of a measuring device for determining a measured variable at one end of a rod-shaped product, which in one embodiment includes, for example: an optical displacement sensor including: a light source producing light that is scanned across an entire end face of the rod-shaped product to be examined; and a light detector for detecting light that is reflected at the end face of the rod-shaped product to generate a measuring signal; and a processing device coupled to receive the measuring signal to determine a quantitative profile of the entire end face of the rod-shaped product.

The use of a displacement sensor operating, for example, on a triangulation method permits a quantitative determination of distances in the axial direction of the measured end face. According to the invention, the sensor is designed to sweep over the complete end face of the rod-shaped product to be examined. A quantitative surface profile of the total end face of the rod-shaped product can thus be obtained with a plurality of data points, thereby resulting in extremely detailed information relating to the product quality.

According to one embodiment of the invention, a drop-out volume at the cigarette head may be delimited by the scanned end face and may be determined quantitatively. The drop-out volume at the head which represents, for example, an important quality feature of cigarettes which refers to the empty volume between the desired plane, defined by the edge of the wrapping strip, and the end face formed by the wrapped tobacco material. Based on the detailed surface profile of the end face to examined, which can be determined according to the invention, the drop-out volume at the head can be determined with maximum precision, which is higher by orders of magnitude than the presently available measuring accuracies.

However, the invention is not limited to the previously described application. Alternatively or in addition thereto, it is possible to determine from the measuring signal a geometric characteristic of a wrapping strip for the rod-shaped product and thus a geometric characteristic of the rod-shaped product itself. Geometric characteristics of this type are the average diameter, for example, and/or the circumference of the wrapping strip and/or the eccentricity of the wrapping strip.

The sensor of one embodiment is a two-dimensional optical displacement sensor, wherein the light source is designed to generate a beam fan for realizing a linear scanning of the end face of the rod-shaped product, and wherein the displacement sensor and the end face of the rod-shaped product can be moved relative to each other for a planar scanning of the end face of the rod-shaped product. With the aid of a two-dimensional optical displacement sensor, the measuring time can be reduced considerably for each rod-shaped product and thus also the total measuring time. With this embodiment, the expansion and/or the width of the beam fan at the location of the end face to be examined is preferably larger than the largest diameter of the end face to be examined, so that a movement of the sensor relative to the end face in one direction is sufficient for the complete scanning of the end face.

According to a different embodiment, the sensor is a one-dimensional optical displacement sensor, wherein the light source for generating a light beam is designed to realize a point-by-point scanning of the end face of the rod-shaped product, and wherein for a planar scanning of the end face of the rod-shaped product the displacement sensor and the end face of the rod-shaped product can be moved relative to each other in two directions that are perpendicular to each other. This embodiment may be preferable, for example, from a cost point of view. In general, the sensor therefore is advantageously either a one-dimensional or a two-dimensional optical displacement sensor, wherein for the planar scanning of the end face of the rod-shaped product, the displacement sensor and the end face of the rod-shaped product can be moved relative to each other.

The measuring device may comprise a manipulator for handling the rod-shaped product which, in particular, is designed to exert a shaking and/or jolting movement onto the rod-shaped product. In that case, two measurements can advantageously be realized on each rod-shaped product, namely a measurement taken before the product is subjected to a shaking and/or jolting movement and another measurement taken afterwards. Additional quality information for the examined product can be obtained with these two independent measurements.

According to a further aspect of the invention there is provided a measuring method for determining a measured variable at one end of a rod-shaped product of the tobacco processing industry. According to one embodiment, the method comprises the steps of: scanning light across a total end face of the rod-shaped product with the use of an optical displacement sensor; detecting light that is reflected at the end face of the rod-shaped product to generate a measuring signal; and transmitting the measuring signal to a processing device to determine a quantitative profile of the complete end face of the rod-shaped product.

### BRIEF DESCRIPTION OF THE DRAWINGS

These and other features and advantages of the invention will be further understood from the following detailed description with reference to the accompanying drawings. All elements not needed for a direct understanding have been omitted. The same elements in different Figures are given the same reference numbers, wherein:

FIG. 1 shows a perspective view of a measuring device in the measuring position which is arranged inside a module;

FIG. 2 shows a schematic view of an optical sensor for the measuring device;

FIGS. 3 to 6 show perspective views of the measuring device from FIG. 1 which are intended to illustrate the course of a measuring operation;

FIGS. 7 and 8 show views from above of the end face of the product to be examined, designed to illustrate the scanning operation for a one-dimensional and/or a two-dimensional displacement sensor;

FIGS. 9 and 10 show schematic measuring diagrams taken before and after the rod-shaped product is subjected to vibrations;

FIGS. 11 and 12 show an image (left) and a measured surface profile (right) of the end face of a cigarette, before and after the rod-shaped product is subjected to vibrations; and

FIG. 13 shows a schematic view of a laboratory measuring station for measuring different properties of rod-shaped products.

### DETAILED DESCRIPTION

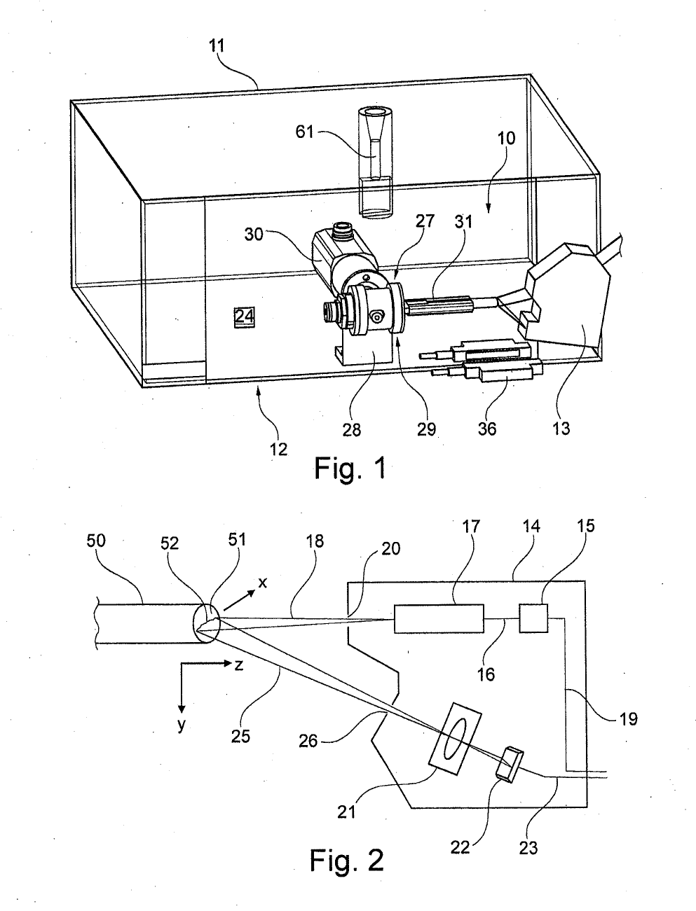

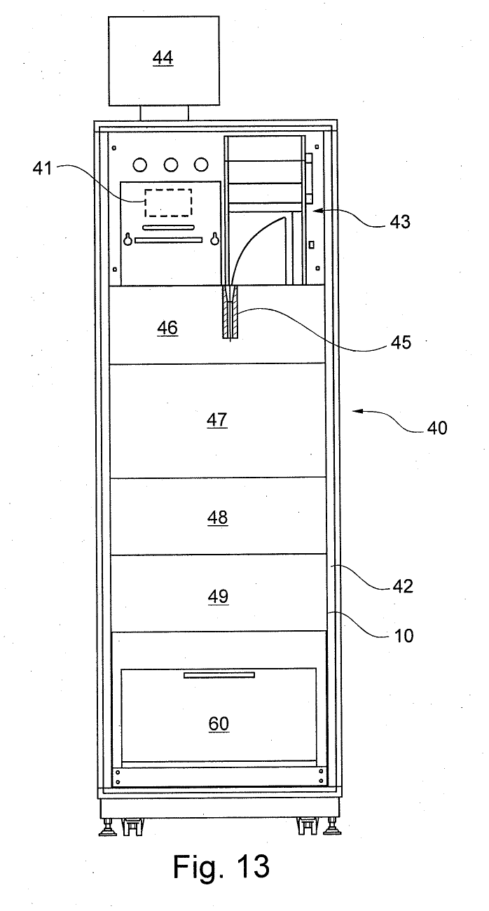

Referring to FIG. 1, there is shown a measuring device 10 arranged inside a housing 11 of, for example, a modular insert 12. This arrangement may be use, for example, in a laboratory measuring station 40, explained in the following with the aid of FIG. 13.

The measuring station 40 may be installed inside a rack and may comprise a loading region 43 for loading a plurality of rod-shaped products of the tobacco processing industry to be examined, in particular cigarettes or filter rods, and a plurality of independent, modular measuring and testing devices 46 to 49 for measuring different properties of the rod-shaped products, such as the weight, pressure loss, ventilation, moisture content, diameter and/or circumference, length, hardness, as well as a collection container 60 for catching the examined rod-shaped products. The measuring station 40 furthermore comprises an electronic signal processing and control device 41 and an operating terminal 44, e.g. a touch-sensitive screen. The measuring and/or testing devices 46 to 49 may be connected to the signal processing and control device 41 via a data bus. At the lower end of the loading region 43, a vertically arranged tube 45 is provided, by means of which the rod-shaped products to be examined and tested are separated and reach the upper test module 46. Similar tubes 61 are respectively provided between the modules 46 to 49 (see FIG. 1 for example), so that a rod-shaped product to be examined passes from the top to the bottom through all measuring modules. A measuring station 40 of this type is therefore also referred to as a drop-through station.

The measuring device 10 according to the invention generally causes damage to the tested products, as described in the following, and therefore may form the last and/or the lowest part of the test module 49 in the measuring station 40.

The measuring device 10 according to FIG. 1 may comprise a manipulator 27, for handling a rod-shaped product to be examined, as well as an optical displacement sensor 13. In view of the modular configuration, the measuring device 10 may be provided with a signal processing and control device which may be separate and independent of the signal processing and control device 41 of the measuring station 40 and may be therefore be designed for controlling the measuring device 10 and for evaluating the measuring signals recorded by the sensor 13. It is useful if the manipulator 27, the sensor 13 and the signal processing and control device 24 are all arranged inside the housing 11.

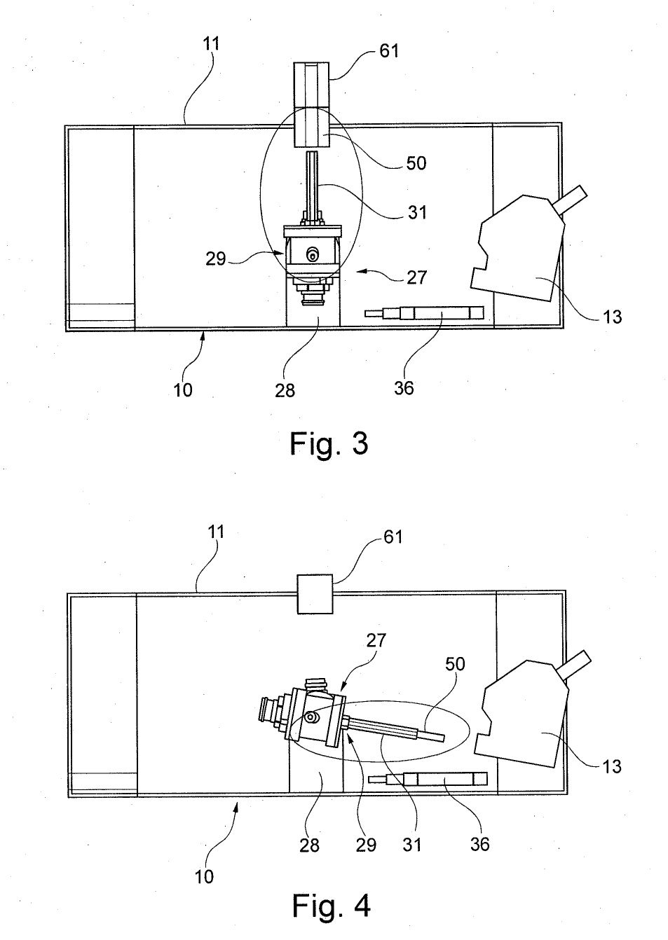

The configuration of an embodiment of the sensor 13 is shown schematically in FIG. 2, wherein there is shown a sensor housing 14 including a light source 15 which generates a light beam 16 and being supplied with power via a line 19. The light source 15 may be a laser light source, in particular from a semiconductor laser such as a laser diode. The sensor 13 furthermore may comprise a beam-expansion element 17, for example a cylindrical lens, for expanding the light beam 16 into a two-dimensional light fan 18, wherein this light fan 18 can also be generated differently.

In the manipulator position depicted in FIG. 1 (measuring position according to FIG. 2), the light fan 18 exits through a window 20 from the sensor 13 and impinges on the surface to be measured, which in this case is the end face 51 at the head end of a cigarette 50, and generates a line 52 thereon, namely the line of intersection between the beam fan 18 plane and the surface 51 to be measured. The light reflected back from the surface 51 is then imaged via an entrance window 26 in the casing 14 and a system of lenses in the sensor 13, for example a two-dimensional lens system and/or an objective 21, on the beam detector 22 which may be a two-dimensional detector and/or a surface detector. The image data detected via the light detector 22 is transmitted via a signal line 23 to the signal processing and control device 24, indicated only schematically in FIG. 1.

As a result of the angle between the incident light (beam fan 18) and the reflected light 25, the precise distance in the longitudinal direction of each point along the line 52 to a corresponding reference point and thus also the precise profile of the lines 52 can be determined quantitatively through triangulation. Longitudinal in this case means along the direction of the incident light 18 (here the z direction) and more precisely along the direction of the center axis for the incident light 18. The shape of the line 52 and thus the surface profile of the surface 51 in the respective cross section are therefore imaged quantitatively on the light detector 22.

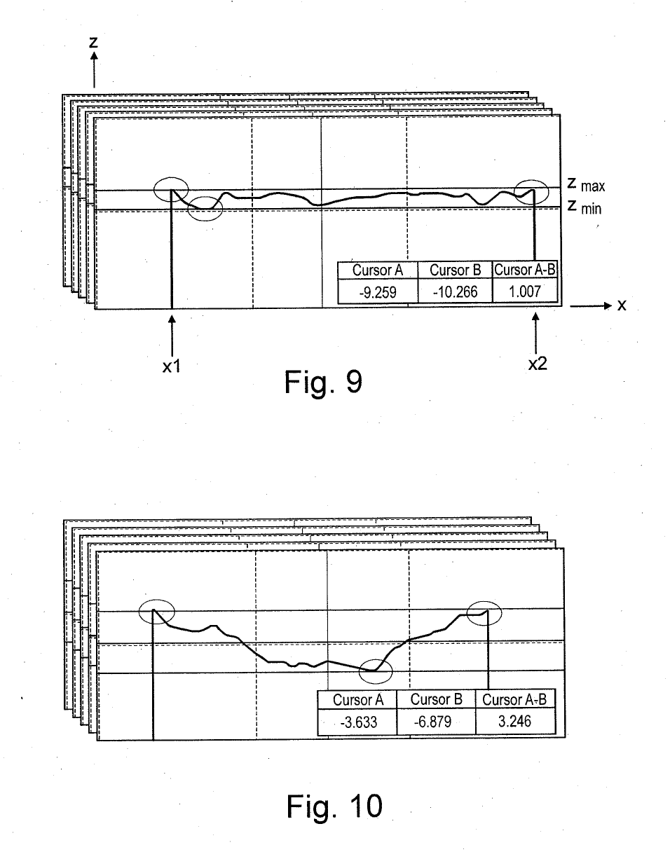

The sensor 13 is preferably embodied so as to achieve a local resolution of 0.2 mm or less, preferably of 0.1 mm or less, so that for each measuring curve (see FIG. 9) at least 50 measuring points are preferably available, even more preferred at least 100 measuring points. Local resolution values that are noticeably below 0.1 mm, with several hundred measuring points per measuring curve, can thus be achieved without problem if necessary.

The angle between the incident light (beam fan 18) and the reflected light 25 generally ranges from 10° to 80°, for achieving a higher precision preferably from 20° to 80°, even more preferable from 30° to 70° and especially preferred from 40° to 60°.

The manipulator 27 comprises a support 28, fixedly mounted on the housing, with thereon arranged holding device 29 that can be pivoted around a horizontal axis with the aid of a pivoting drive 30. The holding device 29 comprises a gripper 31, designed to grip a rod-shaped product 50 and hold it without losing it. The gripper 31 can comprise two jaws provided with longitudinal slots, for example as shown in FIG. 1, between which the rod-shaped product 50 to be examined is clamped in and which can be displaced relative to each other for this purpose. Other types of grippers can, of course, also be used.

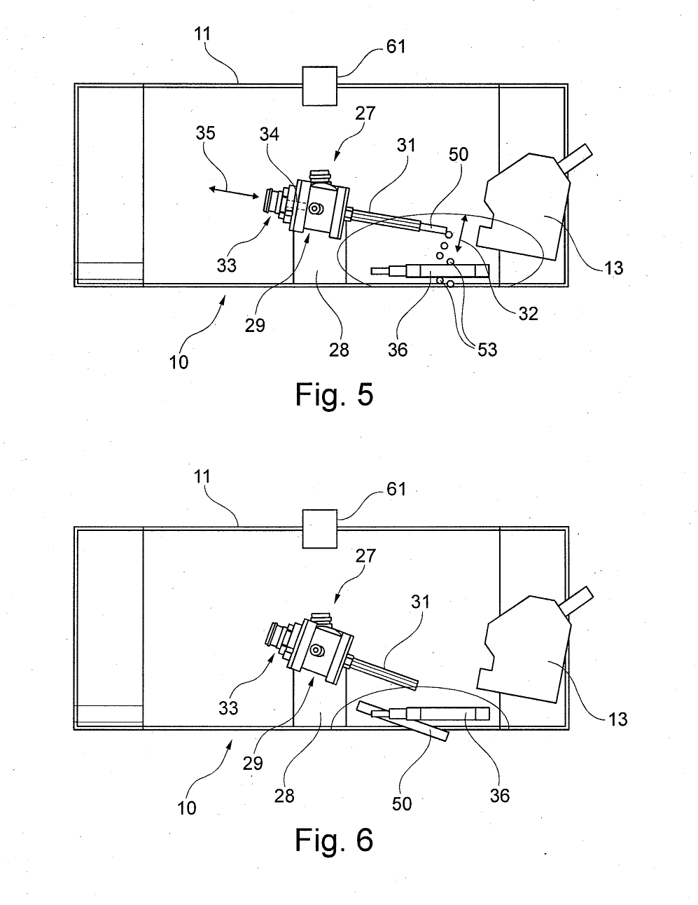

In the following, the course of a measuring operation on a cigarette inside the measuring device 10 according to the invention is explained with the aid of FIGS. 3 to 6 and the example shown in FIG. 1.

At the start of the measuring operation, the holding device 29 is pivoted with the pivoting drive 30 to the vertical position shown in FIG. 3. A cigarette inserted through the tube 61 is picked up by the gripper 31 and clamped in. The holding device 29 is then pivoted by 90° to the measuring position, shown in FIG. 1, wherein the end face 51 at the head end of the cigarette 50 is presented to the sensor 13. The pivoting range for the manipulator is therefore advantageously at least 90°.

To realize the actual measuring operation, the sensor 13 is started up and the end face 51 at the head end of the cigarette 50 is scanned completely. For this purpose, the cigarette 50 and the sensor 13 are moved relative to each other in a direction perpendicular to the beam fan 18, e.g. in a vertical direction herein, so that the beam fan 18 and/or the line 52 can sweep across the complete end face 51 of the cigarette. The relative movement between the cigarette 50 and the sensor 13 during the measuring operation is advantageously caused by pivoting the holding device 29 with the pivoting drive 30. Alternatively, it is also possible to have a vertical displacement of the holding device 29 or a pivoting or displacement of the sensor 13. A measuring curve is recorded after each step of the previously described relative movement between the cigarette 50 and the sensor 13, for example as shown in FIG. 9.

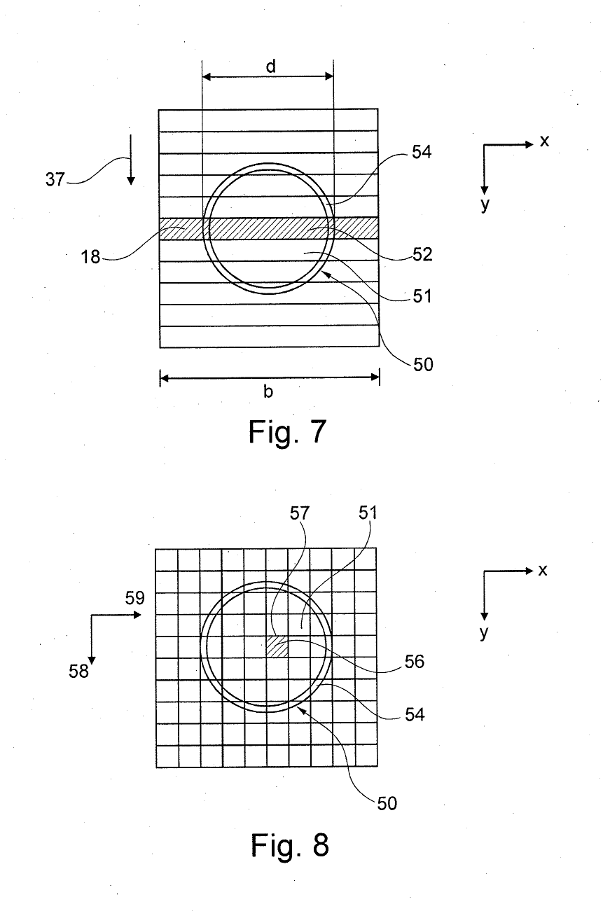

In the following, the scanning movement is explained in further detail with the aid of FIG. 7. FIG. 7 relates to embodiments comprising a two-dimensional displacement sensor 13 and having a light fan 18 as shown in FIGS. 1 and 2. In FIG. 7, the light fan 18 is shown as a cross-sectional view with the aid of a hatched rectangle, at the location where the end face 51 is to be examined. The expansion b of the light fan 18 at the location for examining the end face 51 (see FIG. 7) is advantageously larger than the maximum diameter d of the product to be examined, in particular larger than 10 mm, and even more preferred larger than 15 mm. It is sufficient in that case if the end face 51 to be examined of the product 50 is moved in a scanning direction 37, relative to the light fan 18, to ensure a complete sweep across the end face 51 of the wrapping strip, including the edge 54. FIG. 7 shows 11 scanning positions for this purpose, wherein a measuring curve is recorded at each scanning position. In practical operations, the number of scanning positions for each product 50 is usually considerably higher, depending on the desired resolution for the measurement. According to the above-provided information, the sensor 13 is embodied for sweeping across the complete edge 54 of the wrapping strip 55, wherein the scanning positions can also overlap.

A measuring diagram can be seen in the foreground of FIG. 9 which shows the line 52 detected on the light detector 22 in z direction, above the x direction (see FIG. 2), if the y position is fixed (corresponding to a scanning position in FIG. 7). Owing to the geometric conditions, the irregular curve in FIG. 9 represents a quantitatively precise reproduction (triangulation) of the profile cross section of the surface 51 which corresponds to the line 52. The values on the right and the left edge of the irregular curve shown in FIG. 9, at the positions with references x1 and x2, correspond to the paper edge 54 and/or in general to the edge of the wrapping material for the rod-shaped product 50. At these positions, the measuring curve as a rule reaches the maximum value zmax. In the example shown in FIG. 9, the minimum value zmin of the measuring curve deviates only slightly from the maximum value zmax which indicates an essentially intact tobacco filling at the head end of the cigarette 50.

As previously described, the holding device 29 is then pivoted incrementally, relative to the sensor 13, and a separate measuring curve is recorded following each pivoting step (respectively corresponding to one scanning position in FIG. 7). This is illustrated in FIG. 9 with five super-imposed measuring diagrams, wherein the number of measuring curves recorded for each cigarette in practical operations is in general considerably higher and/or many times higher to achieve a desired high measuring resolution in y direction. The number of measuring curves recorded for each cigarette (number of diagrams in FIG. 9) is preferably computed such that it results in a uniform, desired measuring resolution in both directions (x and y direction in FIG. 2). Thus, the number of measuring curves recorded for each cigarette is therefore advantageously at least 50 and even more preferred at least 100.

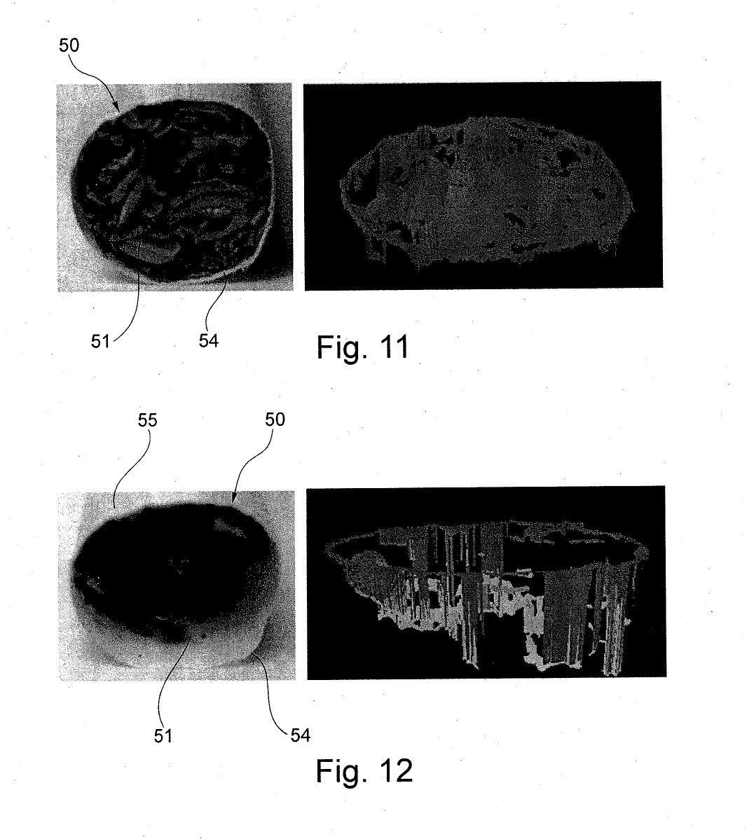

A high-resolution three-dimensional surface profile of the complete end face 51 of the cigarette is obtained in the above-described manner. For example, on the right side of FIG. 11 a measured surface profile is shown of the essentially intact cigarette head, shown in a perspective view on the left side of the same Figure. The term surface profile means that the measured relative distance of the surface 51 in longitudinal direction (z value) is provided for each measuring value in x and y direction. The invention thus provides extremely detailed, quantitative surface information, for example with 10̂3 to 10̂6 or more data points for each measurement. In comparison, the prior art according to the European patent document EP 1 053 942 B1, for example, provides only a single measuring value (this would be a circular, flat disc on the right side of FIG. 11), which is then simply compared to a threshold value to obtain only a binary statement (defective/not defective).

The surface profile with high resolution, shown on the right side of FIG. 11, can advantageously be used to make a highly precise, quantitative determination of the drop-out volume at the head. For the quantitative determination of the head drop-out volume, the distance for all z values are added up, in particular relative to the z value for the paper edge 54 (zmax see FIG. 9). The resulting measured value for the head drop-out volume is extremely precise, in contrast to the value obtained with traditional measuring devices. The use of the longitudinal position (z value) of the paper edge 54 as a reference value makes it possible to obtain a particularly precise result. A further quality value is the maximum depth of the drop-out volume at the head, which follows from the difference between zmax and zmin (see FIG. 9) and is measured, for example, in millimeters. For the described application, the measuring device 10 can therefore function as a device for determining the drop-out at the head side of the cigarette.

For an alternative or additional application, geometric variables can be determined, e.g. the diameter and/or the circumference of the wrapping strip or the cigarette at the cigarette head and/or its eccentricity (oval shape). The circumference of the cigarette follows, for example, from the outer circumference of the measured paper edge 54 (see FIG. 11 on the right), as seen in a view from above of the end face 51. With this application, the measuring device 10 can replace, if applicable, traditional measuring modules used to determine the geometric dimensions of the products in the measuring station 40.

Also conceivable, of course, is a combination of the above-described applications (measuring of the drop-out at the head and measuring of the geometric dimensions of the wrapping strip 55). The invention is not restricted to the above described applications.

According to a preferred embodiment, the cigarette 50 is subjected to a shaking and/or jolting movement following the above described measuring operation. For this purpose, the cigarette 50 is pivoted with the aid of the holding device to a downward slanted position, relative to the horizontal line, as shown in FIG. 4. The angle of inclination is preferably in the range of 5° to 45°, for example 10°. However, greater angles of inclinations between 45° and 90° are conceivable as well.

In this position, the cigarette 50 is shaken and/or is jolted, as shown in FIG. 5. The holding device 29 is preferably embodied for subjecting the cigarette 50 to such a shaking and/or jolting movement. To be more precise, the cigarette 50 is preferably shaken in a direction having a component that is perpendicular to its longitudinal axis, wherein this is illustrated in FIG. 5 with the double arrow 32. The shaking movement can advantageously be generated with the pivoting drive 30. However, the shaking movement can also be generated differently, for example with a separate motor with unbalance. The amplitude for the shaking movement is preferably in the range of +−1 mm to +−10 mm, for example +−4 mm. The frequency of the shaking movement advantageously ranges from 2 to 50 Hz, for example 10 Hz. The time period for the shaking or vibrating movement is advantageously in the range of is 1 s to 20 s, for example 4 s.

The cigarette 50 is advantageously subjected to a jolting movement, in particular in the axial direction (double arrow 35). Used for this can be a jolt actuator 33, shown only incompletely in FIG. 5, which can comprise an axial tappet that acts upon the end face of the filter and can be operated pneumatically. The amplitude of the axial jolting movement is preferably in the range of 1 mm to 10 mm, for example 3 mm. The frequency of the jolting movement advantageously ranges from 0.5 to 10 Hz, for example 2 Hz, with the number of jolts being in the range of 2 to 20, for example 8.

As a result of the above-described shaking and jolting movement, a certain amount of tobacco 53 drops out of the head end of the cigarette 50. According to one embodiment, the amount of tobacco that drops out can be determined with the aid of an elongated light barrier 36, arranged below the head end of the cigarette 50, which can best be seen in FIG. 1. The transmitter for the light barrier 36 can be a waveguide. The volume of tobacco that has dropped out because of the shaking/jolting movement, for example measured in mg, can be determined in connection with a calibration value that was previously determined during a calibration measurement and was stored in the signal processing and control device 24.

At the end of the shaking/jolting movement, the cigarette 50 is preferably again pivoted to the measuring position shown in FIG. 1 and another detailed surface profile of the end face 51 of the cigarette 50 is measured with the sensor 13. This is shown, for example, on the right side of FIG. 12 for the cigarette head that is shown on the left side of FIG. 12. Additional quality features, e.g. the drop-out volume at the head, can be determined from the surface profile of the cigarette head following the shaking/jolting movement, wherein this represents a measure for the resistance of the cigarette to the shaking/jolting movement.

Following the completion of the measuring operations, the cigarette 50 is pivoted downward and released from the gripper 31, so that it can fall through an opening, usefully provided in the bottom of the housing 11, and into the collection container 60 arranged below.

FIG. 8 illustrates the invention for an alternative measuring device provided with a one-dimensional displacement sensor which is embodied so as to generate a light beam 56. A cross section of the light beam 56 is shown in FIG. 8 as a hatched rectangle, at the location of the end face 51 to be examined. The light beam 56 creates a corresponding light spot or light point 57 on the end face 51 to be examined. To completely sweep across the end face 51 to be examined, including the edge 54 of the wrapping strip 55, it is necessary for this embodiment to move the end face 51 of the product 50 to be examined in two scanning directions 58, 59, which are arranged perpendicular to each other, relative to the light beam 56. The manipulator 27 thus would have to be designed with two axes for example. FIG. 8 shows 100 scanning positions, wherein a measuring value is recorded at each scanning position. In practical operations, the number of scanning positions for each product is usually considerably higher, depending on the desired resolution for the measurement.

The Figures are only used to describe the measuring operation realized at the head side of the cigarettes. However, the measuring device can also be used, for example, for realizing measurements on the filter side of cigarettes, or at the ends of filter rods, so as to determine quality features on the filter side end of cigarettes or filter rods.

It will be understood that the above description of the present invention is susceptible to various modifications, changes and adaptations, and the same are intended to be comprehended within the meaning and range of equivalents of the appended claims.

What is claimed is:

1. A measuring device for determining a measured variable at one end of a rod-shaped product, comprising:
an optical displacement sensor including:
a light source producing light that is scanned across an entire end face of the rod-shaped product to be examined; and
a light detector for detecting light that is reflected at the end face of the rod-shaped product to generate a measuring signal; and
a processing device coupled to receive the measuring signal to determine a quantitative profile of the entire end face of the rod-shaped product.

2. The measuring device according to claim 1, wherein the rod-shaped product is a product of the tobacco processing industry and the signal processing device is adapted to quantitatively determine from the measuring signal a head drop-out volume of tobacco which is delimited by the scanned end face.

3. The measuring device according to claim 1, wherein the optical displacement sensor is a two-dimensional optical displacement sensor, wherein the light source generates a radiated light fan to realize a linear scanning of the end face of the rod-shaped product, and wherein the displacement sensor and the end face of the rod-shaped product are movable relative to each other to produce a planar scanning of the end face of the rod-shaped product.

4. The measuring device according to claim 3, wherein radiated light fan has an expansion that is greater at a location of the end face to be examined than a maximum diameter of the end face to be examined.

5. The measuring device according to claim 1, further including a manipulator for handling the rod-shaped product.

6. The measuring device according to claim 5, wherein the manipulator is operative to move the rod-shaped product relative to the optical displacement sensor during a measuring operation.

7. The measuring device according to claim 5, wherein the manipulator is pivotable around an axis positioned perpendicular to the axis of the rod-shaped product.

8. The measuring device according claim 5, wherein the manipulator is operative to subject the rod-shaped product to a shaking movement.

9. The measuring device according to claim 5, wherein the manipulator is operative to subject the rod-shaped product to a jolting movement, in an axial direction of the rod-shaped product.

10. The measuring device according to claim 1, wherein the signal processing device is adapted to determine from the measuring signal a geometric characteristic of a wrapping strip of the rod-shaped product.

11. The measuring device according to claim 10, wherein the signal processing device is adapted to determine from the measuring signal at least one of an average diameter of the wrapping strip, a circumference of the wrapping strip and an eccentricity of the wrapping strip.

12. The measuring device according to claim 1, wherein the rod-shaped product is a product of the tobacco processing industry, and the measuring device further includes a light barrier for detecting tobacco material that drops out of the rod-shaped product.

13. The measuring device according to claim 1, wherein the optical displacement sensor comprises a one-dimensional optical displacement sensor, wherein the light source generates a light beam for realizing a point-by-point scanning of the end face of the rod-shaped product, and wherein the optical displacement sensor and the end face of the rod-shaped product are moveable relative to each other in two directions that are perpendicular to each other to effect a planar scanning of the end face of the rod-shaped product.

14. A measuring method for determining a measured variable at one end of a rod-shaped product, comprising the steps of:
scanning light across an entire end face of the rod-shaped product with the use of an optical displacement sensor;
detecting light that is reflected at the end face of the rod-shaped product to generate a measuring signal; and
transmitting the measuring signal to a processing device to determine a quantitative profile of the entire end face of the rod-shaped product.

15. The measuring method according to claim 14, wherein the scanning includes first scanning the end face of the rod-shaped product, and subsequently subjecting the rod-shaped product to at least one of a shaking and jolting movement, and thereafter conducting a second scanning of the end face of the rod-shaped product.
